(19) United States
(12) Patent Application Publication
(10) Pub. No.: US 2025/0292603 A1
(43) Pub. Date: Sep. 18, 2025

(54) FEATURE VECTOR STORAGE-BASED CLASS-INCREMENTAL SEMANTIC SEGMENTATION LEARNING DEVICE AND METHOD

(71) Applicant: UIF (University Industry Foundation), Yonsei University, Seoul (KR)

(72) Inventors: Bum Sub HAM, Seoul (KR); Young Min OH, Seoul (KR); Dong Hyeon BAEK, Seoul (KR)

(21) Appl. No.: 19/222,625

(22) Filed: May 29, 2025

Related U.S. Application Data
(63) Continuation of application No. PCT/KR2023/002142, filed on Feb. 14, 2023.

(30) Foreign Application Priority Data
Dec. 29, 2022 (KR) 10-2022-0189003

(51) Int. Cl. G06V 20/70; G06V 10/764; G06V 10/82

(52) U.S. Cl. CPC G06V 20/70; G06V 10/764; G06V 10/82

(57) ABSTRACT

A class-incremental semantic segmentation learning method includes: obtaining an incremental semantic segmentation neural network by performing incremental learning on the basis of incremental learning data for an additional incremental class on a previously trained existing semantic segmentation neural network to classify an existing learning class according to existing learning data; after incremental learning with class-based feature vectors, extracted from a previous feature map estimated by the previously trained existing semantic segmentation neural network and pre-stored, obtaining a class-based representative feature vector by estimating a correlation between an existing feature map and an incremental feature map obtained from the existing semantic segmentation neural network and the incremental semantic segmentation neural network, respectively; performing transformation learning which sets a class-based rotation matrix on the basis of the class-based representative feature vector; and performing learning by inputting the transformed class-based feature vector into the semantic segmentation neural network using the class-based rotation matrix.

### CROSS-REFERENCE TO RELATED APPLICATIONS

This application is a Bypass Continuation application of PCT International Application No. PCT/KR2023/002142, which was filed on Feb. 14, 2023, and which claims priority from Korean Patent Application No. 10-2022-0189003 filed on Dec. 29, 2022. The entire contents of the aforementioned patent applications are incorporated herein by reference.

### STATEMENT REGARDING PRIOR DISCLOSURES BY THE INVENTOR OR A JOINT INVENTOR

At least one inventor or joint inventor of the present disclosure has made related disclosures (titled “ALIFE: Adaptive Logit Regularizer and Feature Replay for 15 Incremental Semantic Segmentation”) at 36^{th} Conference on Neural Information Processing Systems (NeurIPS 2022) on Oct. 13, 2022, which was included in the information disclosure statement submitted with this application.

### BACKGROUND

### 1. Technical Field

The embodiments disclosed herein relates to a class-incremental semantic segmentation learning device and method, and more particularly, to a feature vector storage-based class-incremental semantic segmentation learning device and method.

### 2. Description of the Related Art

Semantic segmentation refers to assigning an identifiable class to each of multiple pixels of an input image and segmenting them into regions for each class, and can be applied to various application fields such as autonomous driving, medical imaging, and image editing. This semantic segmentation aims to label each pixel of an input image by classifying it into a designated class of an object such as a person, car, or bicycle.

Currently, most semantic segmentation devices are implemented with semantic segmentation neural networks using artificial neural networks. Semantic segmentation neural networks require training to be performed in advance, and the types and number of identifiable classes are already determined when training is performed. In other words, after training is performed, classes that were not provided during training cannot be identified, so semantic segmentation is not possible. However, in reality, there are frequent cases where semantic segmentation for unlearned classes is required, and thus the demand for class-incremental semantic segmentation (CISS) has continued. However, when class-incremental semantic segmentation is required, previously, the artificial neural network had to be completely retrained, including learning data for not only new classes but also classes that had already been learned.

To overcome this inefficiency, research on class-incremental learning (CIL) has been actively conducted recently, which aims to perform additional learning only for newly added classes without relearning existing classes that have already been learned. The biggest problem in class-incremental learning is the catastrophic forgetting phenomenon, where if a semantic segmentation neural network is trained only with learning data for new classes, the information learned for previously trained existing classes is lost, significantly reducing the identification performance for existing classes. Even if class-incremental learning is performed to identify new classes, if the existing classes cannot be identified due to the catastrophic forgetting phenomenon, there is a problem that performing class-incremental learning becomes meaningless.

Accordingly, as a technique to train how to identify new classes while preventing catastrophic forgetting phenomenon, knowledge distillation has been proposed, but even the knowledge distillation technique has limitations in preventing catastrophic forgetting phenomenon.

Accordingly, by performing additional learning using a portion of the learning data used when learning the existing classes for the class-incrementally trained semantic segmentation neural network, the identification performance for the forgotten class is improved. However, if the learning data itself is stored, even if it is a small amount, it requires a very large memory capacity, and there is a problem that learning data is often unobtainable for security or privacy reasons.

Alternatively, a technique has been proposed to generate virtual learning data that can replace learning data using a generative adversarial network, but the technique for generating virtual learning data also requires a large amount of memory capacity, and there is a problem that the performance of the semantic segmentation neural network may be significantly reduced depending on the quality of the generated virtual learning data.

### SUMMARY OF THE INVENTION

The disclosed embodiments are directed to providing a class-incremental semantic segmentation learning device and method that can solve the catastrophic forgetting problem while improving security with a small memory capacity, by storing feature vectors of existing learning data and utilizing them for class-incremental learning.

The disclosed embodiments are directed to providing a class-incremental semantic segmentation learning device and method that can modify a feature vector obtained from an existing semantic segmentation neural network and apply it to an incrementally trained semantic segmentation neural network.

A class-incremental semantic segmentation learning device according to an embodiment comprises one or more processors; and a memory, wherein the processors obtain an incremental semantic segmentation neural network by performing incremental learning on the basis of incremental learning data for an additional incremental class on a previously trained existing semantic segmentation neural network so as to classify an existing learning class according to existing learning data, after incremental learning with class-based feature vectors, extracted from a previous feature map estimated by the previously trained existing semantic segmentation neural network and pre-stored, obtain a class-based representative feature vector by estimating a correlation between an existing feature map and an incremental feature map obtained from the existing semantic segmentation neural network and the incremental semantic segmentation neural network, respectively, perform transformation learning which sets a class-based rotation matrix on the basis of the class-based representative feature vector, and perform further learning by inputting the transformed class-based feature vector into the semantic segmentation neural network using the class-based rotation matrix.

The class-based feature vectors may be obtained by extracting pixel-based feature vectors from the previous feature map estimated by the existing semantic segmentation neural network after previous training, and calculating the average of pixel-based feature vectors with the same class labeled in the existing learning data.

The processors may input the incremental learning data into each of the existing semantic segmentation neural network and the incremental semantic segmentation neural network to obtain the existing feature map and the incremental feature map, and calculate a regularized correlation between the class-based feature vectors and the feature vector for each pixel of the existing feature map to obtain a class-based regularized correlation.

The processors may obtain a class-based representative feature vector for each of the existing and incremental feature maps by weighting each of a feature vector for each pixel extracted from the existing feature map and a feature vector for each pixel extracted from the incremental feature map with the class-based regularized correlation.

The processors may transform the class-based representative feature vector obtained from the existing feature map into a transformed class-based representative feature vector using the class-based rotation matrix, calculate a transformation loss according to the relationship between the transformed class-based representative feature vector and the class-based representative feature vector obtained from the incremental feature map, and set the class-based rotation matrix so that the transformation loss is reduced.

The processors may calculate a fidelity loss calculated as a similarity between the transformed class-based representative feature vector and the class-based representative feature vector obtained from the incremental feature map, calculate a regularization loss by applying a softmax function to the transformed class-based representative feature vector, and calculate the transformation loss by weighting the fidelity loss and the regularization loss.

The processors may input the transformed class-based feature vector using the class-based rotation matrix during the further learning into a classification module of the incremental semantic segmentation neural network including a feature extraction module and the classification module, and calculate the difference between the class classified by the classification module and the class of the class-based feature vector as an additional loss and perform backpropagation.

The processors may fix the feature extraction module so that the additional loss is not backpropagated during the further learning.

A class-incremental semantic segmentation learning method according to an embodiment comprises the steps of: obtaining an incremental semantic segmentation neural network by performing incremental learning on the basis of incremental learning data for an additional incremental class on a previously trained existing semantic segmentation neural network so as to classify an existing learning class according to existing learning data; after incremental learning with class-based feature vectors, extracted from a previous feature map estimated by the previously trained existing semantic segmentation neural network and pre-stored, obtaining a class-based representative feature vector by estimating a correlation between an existing feature map and an incremental feature map obtained from the existing semantic segmentation neural network and the incremental semantic segmentation neural network, respectively; performing transformation learning which sets a class-based rotation matrix on the basis of the class-based representative feature vector; and performing further learning by inputting the transformed class-based feature vector into the semantic segmentation neural network using the class-based rotation matrix.

The class-incremental semantic segmentation learning device and method according to the embodiment stores a feature vector obtained from an existing semantic segmentation neural network, modifies the stored feature vector so that it can be applied to an incrementally trained semantic segmentation neural network, and utilizes it for further learning during class-incremental learning, thereby improving security with a small memory capacity and solving the catastrophic forgetting problem.

### BRIEF DESCRIPTION OF THE DRAWINGS

FIG. 1 schematically illustrates a configuration of a class-incremental semantic segmentation learning device according to an embodiment of the present disclosure, divided according to the operations performed.

FIG. 2 illustrates an example of a detailed configuration of a transformation learning module of FIG. 1.

FIG. 3 illustrates a class-incremental semantic segmentation learning method according to an embodiment of the present disclosure.

FIG. 4 is a drawing for explaining a computing environment including a computing device according to an embodiment of the present disclosure.

### DETAILED DESCRIPTION OF THE INVENTION

Hereinafter, exemplary embodiments of the present disclosure will be described in detail with reference to the drawings. The following detailed description is provided to help comprehensive understanding of a method, an apparatus, and/or a system disclosed herein. However, this is merely exemplary, and the present disclosure is not limited thereto.

While describing the present disclosure, when it is determined that a detailed description of a known art related to the present disclosure may unnecessarily obscure the gist of the present disclosure, the detailed description will be omitted. Terms which will be used below are defined in consideration of functionality in the present disclosure, which may vary according to an intention of a user or an operator or a usual practice. Therefore, definitions thereof should be made on the basis of the overall contents of this specification. Terminology used herein is for the purpose of describing exemplary embodiments of the present disclosure only and is not intended to be limiting. The singular forms are intended to include the plural forms as well, unless the context clearly indicates otherwise. It should be understood that the terms “comprises,” “comprising,” “includes,” and “including,” when used herein, specify the presence of stated features, numerals, steps, operations, elements, or combinations thereof, but do not preclude the presence or addition of one or more other features, numerals, steps, operations, elements, or combinations thereof. Also, terms such as “unit”, “device”, “module”, “block”, and the like described in the specification refer to units for processing at least one function or operation, which may be implemented by hardware, software, or a combination of hardware and software.

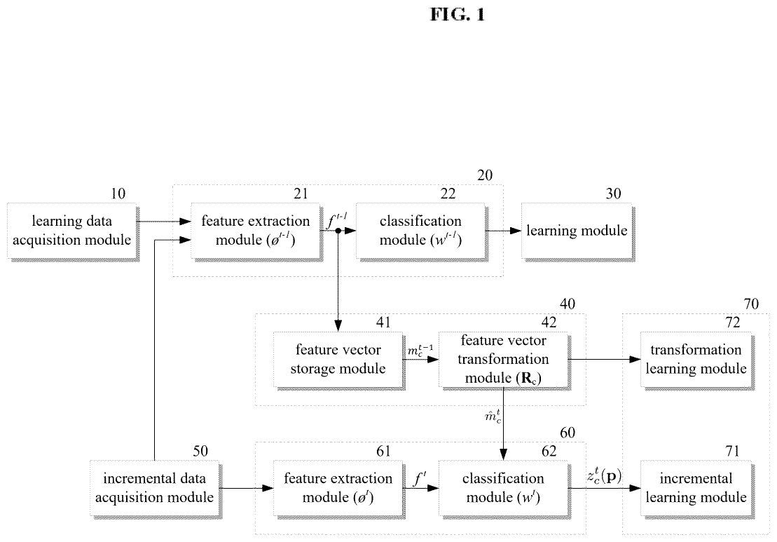

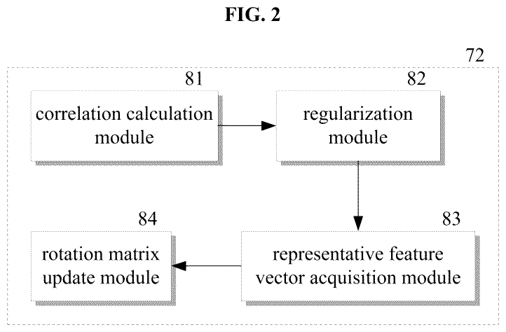

FIG. 1 schematically illustrates a configuration of a class-incremental semantic segmentation learning device according to an embodiment of the present disclosure, divided according to the operations performed, and FIG. 2 illustrates an example of a detailed configuration of a transformation learning module of FIG. 1.

Referring to FIG. 1, a class-incremental semantic segmentation learning device according to an embodiment may include an existing semantic segmentation neural network 20, a feature vector storage and transformation module 40, an incremental data acquisition module 50, an incremental semantic segmentation neural network 60, and an further learning module 70.

However, for the convenience of understanding, FIG. 1 additionally illustrates a learning data acquisition module 10 and a learning module 30, which are components not included in the class-incremental semantic segmentation learning device.

The learning data acquisition module 10 obtains learning data for training the existing semantic segmentation neural network 20. Here, the learning data may be obtained as a plurality of images in which class-based area (A_{c}) containing objects of each class (c∈C^{t}ₚᵣₑᵥ, where C^{t}ₚᵣₑᵥ is an existing class set) to be identified is pre-labeled as a truth value. For example, if the existing semantic segmentation neural network 20 should be able to identify bicycles, vehicles, and airplanes as classes, the learning data may be data in which each class (c) is labeled in pixels (p) of an area (A_{c}) containing bicycles, vehicles, and airplanes in the image.

The existing semantic segmentation neural network 20 may be implemented as an artificial neural network that has been previously trained by the learning module 30 to enable identification of designated existing classes. The existing semantic segmentation neural network 20 may include a feature extraction module 21 and a classification module 22. This is a configuration of a general semantic segmentation neural network, and the feature extraction module 21 performs a neural network operation on an input image to extract features and obtain a feature map f^{t-1}. Then, the classification module 22 receives the feature map f^{t-1} from the feature extraction module 21, performs neural network operations, and identifies and outputs a class for each pixel (p) of the input image. The classification module 22 may receive the feature vector (f^{t-1}(p)) for each pixel (p) from the feature map (f^{t-1}), perform operations with a plurality of weight vectors (w_{c}^{t-1}) set for each class by learning, and estimate the class-based logit (z_{c}^{t-1}(p)) for each pixel, thereby identifying the class of the pixel (p) at each location in the image. In this case, the classification module 22 may transform the class-based logit (z_{c}^{t-1}(p)) for each estimated pixel into a class-based probability value (p_{c}^{t-1}(p)) using a softmax function, etc., and classify the class (c) having the highest probability value (p_{c}^{t-1}(p)) in each pixel (p) as the class (c) of the corresponding pixel (p).

Here, the learned weight matrix of the feature extraction module 21 can be expressed as Φ^{t-1}, the learned weight matrix of the classification module 22 can be expressed as w^{t-1}, and the class-based logit (z_{c}^{t-1}(p)) can be calculated as the inner product of the feature vector (f^{t-1}(p)) for each pixel (p) and the weight vector (w_{c}^{t-1}) for each class in the weight matrix (w^{t-1}).

The learning module 30 trains the existing semantic segmentation neural network 20 to identify the existing classes specified, and calculates and backpropagates the difference between the class labeled with the truth value in the learning data and the class identified by the classification module 22 of the existing semantic segmentation neural network 20 to train the existing semantic segmentation neural network 20. For example, the learning module 30 may train the existing semantic segmentation neural network 20 by calculating the difference between the class-based probability for each pixel (p) estimated by the classification module 22 and the class labeled with the truth value as cross-entropy loss and backpropagating it.

The configuration of the above-mentioned existing semantic segmentation neural network 20 and the learning method using the learning data acquisition module 10 and learning module 30 are known technologies and therefore are not described in detail here.

The incremental data acquisition module 50 obtains incremental learning data for training the incremental semantic segmentation neural network 60 to identify and classify newly added incremental classes (c∈C^{t}_{new}, where C^{t}_{new} is a set of incremental classes) in addition to classes that have been previously learned and can be classified. The incremental data acquisition module 50 can obtain a plurality of images, as incremental learning data, which include objects of incremental classes that the incremental semantic segmentation neural network 60 must additionally identify, and in which areas (A^{t}_{new}, where

$${A}_{new}^{t} = {⋃}_{c ∈ {C}_{new}^{′}} {A}_{c} )$$

containing the incremental classes are pre-labeled as truth values.

However, since the class-incremental semantic segmentation learning device aims at learning about incremental classes, the incremental data acquisition module 50 may obtain incremental learning data in which only the regions corresponding to the incremental classes are labeled with truth values, and the remaining regions are masked. This is to improve the efficiency of incremental learning and enhance the learning speed. As an example, assuming that the existing semantic segmentation neural network 20 can identify bicycles, vehicles, and airplanes as classes through existing learning, and the incremental semantic segmentation neural network 60 is trained to identify people as the incremental class, in this case, if the image is an image of two people riding a bicycle together, the label of the obtained incremental learning data can be labeled with truth values only for the region corresponding to people, and the rest can be masked.

The incremental semantic segmentation neural network 60 is an artificial neural network that is trained to identify incremental classes that are newly added in addition to existing classes that the existing semantic segmentation neural network 20 can identify. Since the incremental semantic segmentation neural network 60 is a neural network that performs further learning on the existing semantic segmentation neural network 20, the incremental semantic segmentation neural network 60 and the existing semantic segmentation neural network 20 have basically the same architecture. Therefore, the incremental semantic segmentation neural network 60 also has a feature extraction module 61 and a classification module 62 identical to the existing semantic segmentation neural network 20.

Each of the feature extraction module 61 and the classification module 62 may have the same architecture as the feature extraction module 21 and the classification module 22, but hereinafter, for convenience of explanation, the feature extraction module 21 and the classification module 22 are referred to as the existing feature extraction module 21 and the existing classification module 22, respectively, and the feature extraction module 61 and the classification module 62 are referred to as the incremental feature extraction module 61 and the incremental classification module 62, respectively.

The incremental feature extraction module 61 and the incremental classification module 62 have weight matrices (Φ^{t-1}, w^{t-1}) set so that they can already identify existing classes through previous learning, and as incremental learning is performed so that identification of the incremental class is possible, the weight matrix (Φ^{t-1}, w^{t-1}) can be updated to weight matrix (Φ^{t}, w^{t}).

The incremental feature extraction module 61 receives an image included in the incremental learning data received from the incremental data acquisition module 50 and extracts features through neural network operations to obtain a feature map (f^{t}). Then, the incremental classification module 62 receives the feature map (f^{t}) from the incremental feature extraction module 61, performs a neural network operation, identifies a class for each pixel (p) of the input image, and outputs it. The incremental classification module 62 may also extract a feature vector (f^{t}(p)) for each pixel (p) from the feature map (f^{t}), and perform an inner product operation between the extracted feature vector (f^{t}(p)) for each pixel (p) and a plurality of weight vectors (w_{c}^{t}) for each class from a weight matrix (w^{t}) updated and set by incremental learning to estimate a class-based logit (z_{c}^{t-1}(p), z_{c}^{t}(p)=w_{c}^{t}·f^{t}(P)) for each pixel (p), and transform it into a class-based probability value (p_{c}^{t}(p)) using a softmax function, etc. to classify the class.

The further learning module 70 performs class-incremental learning on the incremental semantic segmentation neural network 60 to update the existing weight matrix (Φ^{t-1}, w^{t-1}) of the incremental feature extraction module 61 and the incremental classification module 62 of the incremental semantic segmentation neural network 60 to the weight matrix (Φ^{t}, w^{t}).

The further learning module 70 may include an incremental learning module (71). Similar to the learning module 30 that trains the existing semantic segmentation neural network 20, the incremental learning module 71 may calculate the difference between the class labeled with the truth value in the incremental learning data obtained from the incremental data acquisition module 50 and the class identified by the incremental classification module 62 of the incremental semantic segmentation neural network 60 as cross-entropy loss and backpropagate it to incrementally train the incremental semantic segmentation neural network 60. However, as described above, when performing incremental learning using only the incremental learning data, the incremental semantic segmentation neural network 60 can accurately classify the incremental class learned with the incremental learning data, while the classification performance for the existing class that the existing semantic segmentation neural network 20 can accurately classify is rather degraded due to the catastrophic forgetting phenomenon.

In order to suppress the degradation of classification performance for existing classes due to the catastrophic forgetting phenomenon, the incremental learning module 71 may incrementally train the incremental semantic segmentation neural network 60 by applying losses according to various techniques in addition to the cross-entropy loss. For example, the incremental learning module 71 may incrementally train the incremental semantic segmentation neural network 60 by applying the knowledge distillation technique. In the knowledge distillation technique, the image of the incremental learning data is applied to not only the incremental semantic segmentation neural network 60 but also the existing semantic segmentation neural network 20, and the existing semantic segmentation neural network 20 and the incremental semantic segmentation neural network 60 each compare the class-based logits for the existing classes extracted from the applied image of the incremental learning data, calculate the difference between the class-based logits for the same class as knowledge distillation loss, and backpropagate it, thereby enabling the classification performance of the incremental semantic segmentation neural network 60 for the existing classes to follow the existing semantic segmentation neural network 20 as much as possible. That is, in the process of the incremental semantic segmentation neural network 60 performing incremental learning to identify the incremental class based on the incremental learning data, the probability estimated for the existing classes is made similar to the probability estimated by the existing semantic segmentation neural network 20, thereby maintaining the classification performance for the existing classes.

Here, it is assumed that the incremental semantic segmentation neural network 60 performs incremental learning for the incremental semantic segmentation neural network 60 using cross-entropy loss (L_{CCE}) and knowledge distillation loss (L_{KD}), but it is not limited thereto.

However, it has already been confirmed that even if various existing techniques known at present, including the knowledge distillation technique, are applied, the catastrophic forgetting phenomenon is not suppressed to the required level. In other words, if various existing techniques are applied, the catastrophic forgetting phenomenon can be alleviated to some extent, but it still occurs, resulting in a decrease in the classification performance of the existing class of the incremental semantic segmentation neural network 60. In particular, since class-incremental learning must be performed repeatedly whenever a new class to be classified by the semantic segmentation neural networks (20, 50) is added, the classification performance for the initially learned class can be significantly reduced after the class-incremental learning is performed repeatedly.

Due to these problems, in the past, a small amount of the learning data for the existing class obtained by the learning data acquisition module 10 was stored separately, and the incremental semantic segmentation neural network 60 that has been incrementally trained was further trained for the existing class, thereby enabling the incremental semantic segmentation neural network 60 to exhibit excellent classification performance for the existing class as well. However, in order to perform this further learning, the learning data for the existing class must be stored, and even if it is a small amount, the size of the learning data is very large, so a large amount of storage capacity is required. In particular, in the case of medical images, etc., storing the learning data itself is often legally restricted in terms of personal information protection and security.

Alternatively, a method of directly generating learning data for existing classes using a generative adversarial network has been proposed, but this is also inefficient because the memory capacity and computational resources required by the generative adversarial network are very large.

To overcome these limitations, the class-incremental semantic segmentation learning device of the embodiment may not store learning data for existing classes as they are, but store class-based feature vectors (m_{c}^{t-1}) in vector form, and include a feature vector storage and transformation module 40 that transforms the values of the stored class-based feature vectors (m_{c}^{t-1}) into transformed class-based feature vectors (\hat{m}_{c}^{t}) having values suitable for the incremental semantic segmentation neural network 60, and the incremental learning module 71 may perform further learning for the incremental semantic segmentation neural network 60 based on the vectors transformed by the feature vector storage and transformation module 40.

Since the further learning is merely auxiliary learning performed so that the incrementally trained incremental semantic segmentation neural network 60 can also identify existing classes well, the incremental learning module 71 may fix the weight matrix (<Dt) set by incremental learning in the incremental feature extraction module 61 of the incremental semantic segmentation neural network 60 during further learning so that it does not change, and update only the weight matrix (w^{t}) of the incremental classification module 62 by fine tuning it based on the transformed class-based feature vector (\hat{m}_{c}^{t}).

Specifically, the feature vector storage and transformation module 40 may include a feature vector storage module 41 and a feature vector transformation module 42.

The feature vector storage module 41 receives a feature vector (f^{t-1}(p)) for each pixel (p) obtained from a feature map (f^{t-1}) extracted from an image of learning data by the existing feature extraction module 21 of the existing semantic segmentation neural network 20, and obtains and stores a class-based feature vector (m_{c}^{t-1}).

The feature vector storage module 41 classifies the received feature vector (f^{t-1}(p)) for each pixel (p) into classes according to the truth value labeled in the learning data. Then, the feature vector (f^{t-1}(p)) for each pixel (p) classified into classes may be averaged to obtain and store the class-based feature vector (m_{c}^{t-1}). The class-based feature vector (m_{c}^{t-1}) can be obtained according to Equation 1.

$${m}_{C}^{t - 1} = \frac{1}{\vert {R}_{c} \vert} {\sum }_{p ∈ {R}_{c}} {f}^{t - 1} ( p ) \qquad [ Equation 1 ]$$

In this case, the existing feature extraction module 21 may be configured to obtain multiple (for example, S) feature vectors (f^{t-1}(p)) for each pixel (p), and thus, the class-based feature vector (m_{c}^{t-1}) may also be obtained as multiple class-based feature vectors (m_{c}^{t-1}(s), where s∈S) for each class.

Since the class-based feature vector (m_{c}^{t-1}(s)) has the class-based features extracted from the learning data by the existing semantic segmentation neural network 20, it is not only suitable data for further learning, but also has a very small size compared to the learning data, so even if multiple class-based feature vectors (m_{c}^{t-1}(s)) are obtained for each class, it requires extremely small storage space compared to the case where the learning data is directly stored. In other words, the incremental semantic segmentation neural network 60 can be effectively further trained even with a small storage capacity.

However, the incremental feature extraction module 61 of the incremental semantic segmentation neural network 60 and the existing feature extraction module 21 of the existing semantic segmentation neural network 20 are not the same as each other by incremental learning. That is, the weight matrix (Φ^{t-1}) of the existing feature extraction module 21 and the weight matrix (Φ^{t}) of the incremental feature extraction module 61 are different from each other. Therefore, the class-based feature vector (m_{c}^{t-1}) generated based on the feature vector (f^{t-1}(p)) obtained from the feature map (f^{t-1}) obtained from the existing feature extraction module 21 cannot be input as is to the incremental classification module 62.

Accordingly, the feature vector transformation module 42 transforms the class-based feature vector (m_{c}^{t-1}(s)) stored in the feature vector storage module 41 into a transformed class-based feature vector (\hat{m}_{c}^{t}) having a value corresponding to the feature vector (f^{t}(p)) extracted from the incremental feature extraction module 61 of the incremental semantic segmentation neural network 60.

The feature vector transformation module 42 sets a class-based rotation matrix (R_{c}) whose element values are determined by learning, and uses the set class-based rotation matrix (R_{c}) to transform the class-based feature vector (m_{c}^{t-1}(s)) into a transformed class-based feature vector (\hat{m}_{c}^{t}) as in Equation 2.

The feature vector transformation module 42 may set a class-based rotation matrix (R_{c}) whose element values are determined by learning, and use the set class-based rotation matrix (R_{c}) to transform the class-based feature vector (mₑ^{t-1}(s)) into a transformed class-based feature vector (\hat{m}_{c}^{t}) as in Equation 2.

$${\hat{m}}_{c}^{t} ( s ) = {R}_{c} {m}_{c}^{t - 1} ( s ) \qquad [ Equation 2 ]$$

That is, the feature vector transformation module 42 uses a class-based rotation matrix (R_{c}) to transform the class-based feature vector (m_{c}^{t-1}(s)) into a transformed class-based feature vector (\hat{m}_{c}^{t}) that is compatible with the incremental feature extraction module 61 and the incremental classification module 62 of the incremental semantic segmentation neural network 60 and apply it to the incremental classification module 62, thereby allowing the incremental learning module 71 to perform further learning to fine-tune the weights of the incremental classification module 62 of the incremental semantic segmentation neural network 60.

However, in order for the feature vector transformation module 42 to transform the class-based feature vector (m_{c}^{t-1}(s)) into the transformed class-based feature vector (\hat{m}_{c}^{t}) using the class-based rotation matrix (R_{c}), the element values of the class-based rotation matrix (R_{c}) must first be determined through learning.

Accordingly, in the embodiment, the further learning module 70 may further include a transformation learning module 72 that performs transformation learning to set a class-based rotation matrix (R_{c}) of the feature vector transformation module 42.

The transformation learning module 72 may perform transformation learning before performing further learning to fine-tune the weights of the incremental classification module 62 based on the transformed class-based feature vector (\hat{m}_{c}^{t}) after the incremental learning module 71 of the further learning module 70 performs incremental learning based on the incremental learning data. That is, after the weight matrix (Φ^{t-1}, w^{t-1}) of the incremental feature extraction module 61 and the incremental classification module 62 in the incremental semantic segmentation neural network 60 is updated to the weight matrix (Φ^{t}, w^{t}) by incremental learning, transformation learning may be performed.

During transformation learning, the weight matrix (Φ^{t}, w^{t}) of the incremental feature extraction module 61 and the incremental classification module 62 is fixed and does not change.

Here, the class-based rotation matrix (R_{c}) is a matrix defined by the Cayley transform, and at the beginning of transformation learning, the class-based rotation matrix (R_{c}) for each class of the feature vector transformation module 42 may have its element values set based on the class-based strictly upper triangular matrix (U_{c}) whose values are initialized to arbitrary values.

Specifically, when the elements of the class-based strictly upper triangular matrix (U_{c}) are initialized to arbitrary values, a class-based skew-symmetric matrix (S_{c}) can be obtained according to Equation 3.

$${S}_{c} = {U}_{c} - {U}_{c}^{⊤} \qquad [ Equation 3 ]$$

In addition, from the class-based skew-symmetric matrix (S_{c}) obtained according to Equation 3, the initial class-based rotation matrix (R_{c}) can be obtained according to Equation 4.

$${R}_{c} = ( I - {S}_{c} ) {( I + {S}_{c} )}^{- 1} \qquad [ Equation 4 ]$$

In Equation 4, I is the identity matrix where I=R_{c}R_{c}^{T}=R_{c}^{T}R_{c}, c∈cₚᵣₑᵥ^{t}.

The transformation learning module 72 may include a correlation calculation module 81, a regularization module 82, a representative feature vector acquisition module 83, and a rotation matrix update module 84.

The transformation learning module 72 inputs an image of incremental learning data into each of the incremental feature extraction module 61 of the incremental semantic segmentation neural network 60 having an updated weight matrix (Φ^{t}) through incremental learning and the existing feature extraction module 21 of the existing semantic segmentation neural network 20 having a previous weight matrix (Φ^{t-1}), thereby obtaining existing and incremental feature maps (f^{t-1}, f^{t}).

The correlation calculation module 81 calculates the class-based correlation (v_{c}(p)) for each pixel between a plurality of class-based feature vectors (m_{c}^{t-1}(s)) stored in the feature vector storage module 41 and the feature vector (f^{t-1}(p)) for pixels extracted from the existing feature map (ft-1) according to Equation 5.

$${v}_{c} ( p ) = {\sum }_{s = 1}^{S} ReLU ( \frac{{f}^{t - 1} ( p )}{‖ {f}^{t - 1} ( p ) ‖} \cdot \frac{{m}_{c}^{t - 1} ( s )}{‖ {m}_{c}^{t - 1} ( s ) ‖} ) \qquad [ Equation 5 ]$$

Here, ReLU is the Rectified Linear Unit function, and ∥·∥ is the L1-norm function.) The regularization module 82 may obtain the class-based regularized correlation (σ_{c}(p)) by regularizing the calculated class-based correlation (v_{c}(p)) when the class-based correlation (v_{c}(p)) for each pixel is calculated according to Equation 5. The class-based regularized correlation (σ_{c}(p)) may be obtained by applying the softmax function to the class-based correlation (v_{c}(p)) as in Equation 6, for example.

$${σ}_{c} ( p ) = \frac{{e}^{{τυ}_{c} ( p )}}{{\sum }_{p} {e}^{τ {υ}_{c} ( p )}} \qquad [ Equation 6 ]$$

Here, τ is the temperature value.

When the class-based regularized correlation is calculated according to Equation 6, the representative feature vector acquisition module 83 may obtain the existing class-based representative feature vector (r_{c}^{t-1}) for the existing feature map (f^{t-1}) and the incremental class-based representative feature vector (r_{c}t) for the incremental feature map (f^{t}) according to Equation 7.

$${r}_{c}^{t - 1} = {\sum }_{p} {σ}_{c} ( p ) {f}^{t - 1} ( p ) , \qquad [ Equation 7 ]$$

$${r}_{c}^{t} = {\sum }_{p} {σ}_{C} ( p ) {f}^{t} ( p )$$

According to Equation 7, the class-based representative feature vectors (r_{c}^{t-1}, r_{c}^{t}) can be obtained by weighting each of the feature vectors (f^{t-1}(p)) for each pixel of the existing feature map (f^{t-1}) and the feature vectors (f^{t}(p)) for each pixel of the incremental feature map (f^{t}) with the class-based regularized correlation (σ_{c}(p)).

As in Equation 2, the class-based rotation matrix (R_{c}) that transforms the class-based feature vector (m_{c}^{t-1}(s)) into the transformed class-based feature vector (\hat{m}_{c}^{t}) should also be equally applicable to the class-based representative feature vector (r_{c}^{t-1}, r_{c}^{t}) of Equation 7.

That is, when transforming the class-based representative feature vector (r_{c}^{t-1}) for the existing feature map (f^{t-1}) into the transformed class-based representative feature vector (\hat{r}_{c}^{t}, here \hat{r}_{c}^{t}=R_{c}r_{c}^{t-1}) using the class-based rotation matrix (R_{c}), the transformed class-based representative feature vector (\hat{r}_{c}^{t}) must have similar characteristics to the class-based representative feature vector (r_{c}^{t}) for the incremental feature map (f^{t}). In addition, it must be able to have regularized probability values in the entire class set (C^{t}ₐₗₗ) including the existing class set (C^{t}ₚᵣₑᵥ) and the incremental class set (C^{t}_{new}).

Accordingly, the rotation matrix update module 84 may define the transformation loss (L_{S2}) as a weighted sum of the fidelity loss (L_{FID}) and the regularization loss (L_{REG}) as in Equation 8, calculate the transformation loss (L_{S2}) defined according to Equation 8, and update the element values of the class-based rotation matrix (R_{c}) so that the transformation loss (L_{S2}) is reduced.

$${L}_{S 2} = {λ}_{ROT} {L}_{FID} + ( 1 - {λ}_{ROT} ) {L}_{REG} \qquad [ Equation 8 ]$$

(Here, λ_{ROT} is the loss balancing weight.)

In Equation 8, the fidelity loss (L_{FID}) can be calculated as the similarity between the transformed class-based representative feature vector (\hat{r}_{c}^{t}) and the class-based representative feature vector (r_{c}^{t}) according to Equation 9, and the regularization loss (L_{REG}) can be calculated in the form of a probability value obtained by applying the softmax function to the transformed class-based representative feature vector (\hat{r}_{c}^{t}) according to Equation 10.

$${L}_{FID} = {\sum }_{c ∈ {C}_{prev}^{t}} ( 1 - \frac{{\hat{r}}_{c}}{‖ {\hat{r}}_{c} ‖} \cdot \frac{{r}_{c}^{t}}{‖ {r}_{c}^{t} ‖} ) \qquad [ Equation 9 ]$$

$${L}_{REG} = {\sum }_{c ∈ {C}_{prev}^{t}} - log ( \frac{{e}^{{\hat{r}}_{c} \cdot {w}_{c}^{t}}}{{\sum }_{i ∈ {C}_{all}^{t}} {e}^{{\hat{r}}_{c} \cdot {w}_{i}^{t}}} ) \qquad [ Equation 10 ]$$

As described above, during transformation learning in which the transformation learning module 72 sets the element values of the class-based rotation matrix (R_{c}), the weight matrix (Φ^{t}, w^{t}) of the incremental feature extraction module 61 and the incremental classification module 62 is fixed and does not change.

Then, during further learning, only the weight matrix (Φ^{t}) of the feature extraction module 61 may be fixed, and the feature vector transformation module 42 may use the class-based rotation matrix (R_{c}) according to Equation 2 to transform the class-based feature vector (m_{c}^{t-1}(s)) stored in the feature vector storage module 41 into the transformed class-based feature vector (\hat{m}_{c}^{t}) and apply it to the incremental classification module 62, and the incremental learning module 71 may calculate an additional loss based on the difference between the class classified by the incremental classification module 62 for the transformed class-based feature vector (\hat{m}_{c}^{t}) and the class of the class-based feature vector (\hat{m}_{c}^{t}), and backpropagate it, thereby fine-tuning the weight matrix (w^{t}) of the incremental classification module 62.

As a result, the class-incremental semantic segmentation learning device according to the embodiment uses the class-based feature vector (m_{c}^{t-1}(s)) obtained as the class-based average feature vector for each pixel in the feature map (f^{t-1}) obtained from learning data by the existing feature extraction module 21 of the existing semantic segmentation neural network 20 trained for the existing class, and the transformed class-based feature vector (\hat{m}_{c}^{t}) that transforms the feature vector (m_{c}^{t-1}(s)) for the semantic segmentation neural network 60 on which incremental learning is performed so as to be identifiable for the incremental class, thereby facilitating further learning that can resolve the catastrophic forgetting phenomenon with a small storage space.

In the illustrated embodiment, each component may have different functions and capabilities other than those described below, and may include additional components other than those described below. In addition, in an embodiment, each component may be implemented using one or more physically separated devices, implemented by one or more processors or a combination of one or more processors and software, and may not be clearly distinguished in specific operations, unlike the illustrated example.

In addition, the class-incremental semantic segmentation learning device shown in FIG. 1 may be implemented in a logic circuit by hardware, firmware, software, or a combination thereof, or may be implemented using a general-purpose or special-purpose computer. The apparatus may also be implemented using a hardwired device, a field programmable gate array (FPGA), an application specific integrated circuit (ASIC), or the like. In addition, the apparatus may be implemented as a System on Chip (SoC) including one or more processors and controllers.

In addition, the class-incremental semantic segmentation learning device may be mounted in the form of software, hardware, or a combination thereof in a computing device or server equipped with hardware elements. The computing device or server may refer to various devices including all or part of communication devices such as communication modems for communicating with various devices or wired/wireless communication networks, a memories that store data for executing programs, microprocessors for executing programs to calculate and command, and the like.

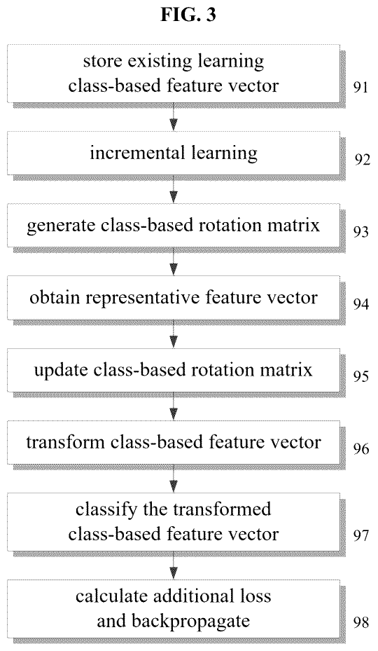

FIG. 3 illustrates a class-incremental semantic segmentation learning method according to an embodiment of the present disclosure.

Referring to FIGS. 1 and 2, the class-incremental semantic segmentation learning method of FIG. 3 will be described. First, while the existing semantic segmentation neural network 20 is trained to identify the existing learning class, the feature vector (f^{t-1}(p)) for each pixel (p) of the feature map (f^{t-1}) estimated by the feature extraction module 21 of the existing semantic segmentation neural network 20 is classified by class and averaged to obtain and store the class-based feature vector (m_{c}^{t-1}) (91).

Then, by performing incremental learning on the existing semantic segmentation neural network 20 based on incremental learning data for additional incremental classes other than the existing classes, (Φ^{t-1}, w^{t-1}) of the existing semantic segmentation neural network 20 is updated to a weight matrix (Φ^{t}, w^{t}), thereby converting it into the incremental semantic segmentation neural network 60 that can perform classification for not only the existing classes but also the incremental classes (92).

When the incremental learning is completed, an initial class-based rotation matrix (R_{c}) is generated to transform the class-based feature vector (m_{c}^{t-1}) so that it can be applied to the incremental semantic segmentation neural network 60 (93). In this case, the class-based rotation matrix (R_{c}) may be generated by generating a class-based skew-symmetric matrix (S_{c}) based on a class-based strictly upper triangular matrix (U_{c}) having an arbitrary value, and using the generated class-based skew-symmetric matrix (S_{c}) and the identity matrix (I) according to Equations 3 and 4.

Once the initial class-based rotation matrix (R_{c}) is generated, incremental learning data is input to each of the existing semantic segmentation neural network 20 and the incremental semantic segmentation neural network 60 to obtain feature maps (f^{t-1}, f^{t}), and class-based representative feature vectors (r_{c}^{t-1}, r_{c}^{t}) of the feature maps (f^{t-1}, f^{t}) are obtained based on the correlation between the obtained feature map (f^{t-1}) and the stored class-based feature vectors (m_{c}^{t-1}(s)) (94).

Then, based on the class-based representative feature vector (r_{c}^{t-1}, r_{c}^{t}), the transformation loss (L_{S2}) is calculated and the element value of the class-based rotation matrix (R_{c}) is updated so that the transformation loss (L_{S2}) is reduced (95). The element value of the class-based rotation matrix (R_{c}) may be updated repeatedly as many times as the transformation loss (L_{S2}) becomes lower than the specified reference transformation loss or as many times as the specified number of times. In this case, the weight matrix (Φ^{t}, w^{t}) of the incremental feature extraction module 61 and the incremental classification module 62 is fixed and does not change.

When the element value is updated and the class-based rotation matrix (R_{c}) is set, the class-based feature vector (m_{c}^{t-1}) is transformed according to Equation 2 using the set class-based rotation matrix (R_{c}) to obtain the transformed class-based feature vector (\hat{m}_{c}^{t}) (96).

Then, the transformed class-based feature vector (\hat{m}_{c}^{t}) is applied to the incremental classification module 62 of the incremental semantic segmentation neural network 60, so that the incremental classification module 62 classifies the class of the transformed class-based feature vector (\hat{m}_{c}^{t}) (97). The difference between the class classified by the incremental classification module 62 and the class of the transformed class-based feature vector (\hat{m}_{c}^{t}) is calculated as an additional loss and backpropagated to fine-tune the weight matrix (w^{t}) of the incremental classification module 62 (98). In this case, the weight matrix (Φ^{t}) of the incremental feature extraction module 61 is fixed.

In FIG. 3, the respective processes are described as being executed sequentially, but this is merely illustrative and those skilled in the art may apply various modifications and changes by changing the order illustrated in FIG. 3 or performing one or more processes in parallel or adding another process without departing from the essential gist of the exemplary embodiment of the present disclosure.

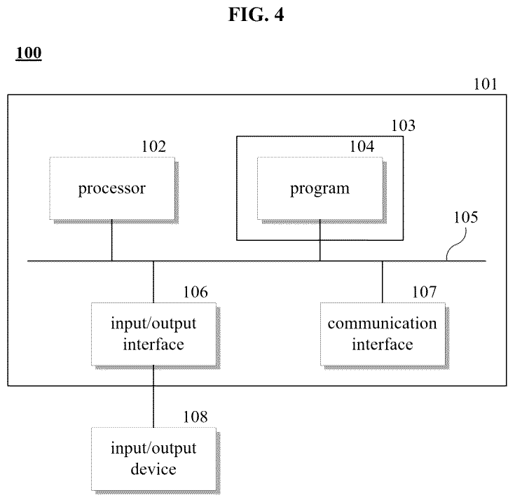

FIG. 4 is a drawing for explaining a computing environment including a computing device according to an embodiment of the present disclosure.

In the illustrated embodiment, each component may have different functions and capabilities other than those described below, and may include additional components other than those described below. The illustrated computing environment 100 may include a computing device 101 to perform the class-incremental semantic segmentation learning method illustrated in FIG. 3. In an embodiment, the computing device 101 may be one or more components included in the class-incremental semantic segmentation learning device shown in FIG. 1.

The computing device 101 includes at least one processor 102, a computer readable storage medium 103 and a communication bus 105. The processor 102 may cause the computing device 101 to operate according to the above-mentioned exemplary embodiment. For example, the processor 102 may execute one or more programs 104 stored in the computer readable storage medium 103. The one or more programs 104 may include one or more computer executable instructions, and the computer executable instructions may be configured, when executed by the processor 102, to cause the computing device 101 to perform operations in accordance with the exemplary embodiment.

The communication bus 105 interconnects various other components of the computing device 101, including the processor 102 and the computer readable storage medium 103.

The computing device 101 may also include one or more input/output interfaces 106 and one or more communication interfaces 107 that provide interfaces for one or more input/output devices 108. The input/output interfaces 106 and the communication interfaces 107 are connected to the communication bus 105. The input/output devices 108 may be connected to other components of the computing device 101 through the input/output interface 106. Exemplary input/output devices 108 may include input devices such as a pointing device (such as a mouse or trackpad), keyboard, touch input device (such as a touchpad or touchscreen), voice or sound input device, sensor devices of various types and/or photography devices, and/or output devices such as a display device, printer, speaker and/or network card. The exemplary input/output device 108 is one component constituting the computing device 101, may be included inside the computing device 101, or may be connected to the computing device 101 as a separate device distinct from the computing device 101.

The present invention has been described in detail through a representative embodiment, but those of ordinary skill in the art to which the art pertains will appreciate that various modifications and other equivalent embodiments are possible. Therefore, the true technical protection scope of the present invention should be defined by the technical spirit set forth in the appended scope of claims.

What is claimed is:

1. A class-incremental semantic segmentation learning device, comprising: one or more processors; and a memory storing one or more programs executed by the one or more processors,
wherein the processors
obtain an incremental semantic segmentation neural network by performing incremental learning on the basis of incremental learning data for an additional incremental class on a previously trained existing semantic segmentation neural network so as to classify an existing learning class according to existing learning data,
after incremental learning with class-based feature vectors, extracted from a previous feature map estimated by the previously trained existing semantic segmentation neural network and pre-stored, obtain a class-based representative feature vector by estimating a correlation between an existing feature map and an incremental feature map obtained from the existing semantic segmentation neural network and the incremental semantic segmentation neural network, respectively,
perform transformation learning which sets a class-based rotation matrix on the basis of the class-based representative feature vector, and
perform further learning by inputting transformed class-based feature vector into the semantic segmentation neural network using the class-based rotation matrix.

2. The class-incremental semantic segmentation learning device according to claim 1,
wherein the class-based feature vectors are obtained by
extracting pixel-based feature vectors from the previous feature map estimated by the existing semantic segmentation neural network after previous training, and
calculating an average of pixel-based feature vectors with the same class labeled in the existing learning data.

3. The class-incremental semantic segmentation learning device according to claim 1,
wherein the processors
input the incremental learning data into each of the existing semantic segmentation neural network and the incremental semantic segmentation neural network to obtain the existing feature map and the incremental feature map, and
calculate a regularized correlation between the class-based feature vectors and a feature vector for each pixel of the existing feature map to obtain a class-based regularized correlation.

4. The class-incremental semantic segmentation learning device according to claim 3,
wherein the processors
obtain a class-based representative feature vector for each of the existing and incremental feature maps by weighting each of a feature vector for each pixel extracted from the existing feature map and a feature vector for each pixel extracted from the incremental feature map with the class-based regularized correlation.

5. The class-incremental semantic segmentation learning device according to claim 3,
wherein the processors
calculate the class-based correlation (v_{c}(p)) for each pixel from the class-based feature vector (m_{c}^{t-1}(s)) and the feature vector (f^{t-1}(p)) for each pixel extracted from the existing feature map (f^{t-1}) according to Equation
$${υ}_{c} ( p ) = {\sum }_{s = 1}^{S} ReLu ( \frac{{f}^{t - 1} ( p )}{‖ {f}^{t - 1} ( p ) ‖} \cdot \frac{{m}_{c}^{t - 1} ( s )}{‖ {m}_{c}^{t - 1} ( s ) ‖} )$$
(wherein, ReLU is the Rectified Linear Unit function, and ∥·∥ is the L1-norm function.), and
apply a softmax function to the calculated class-based correlation (v_{c}(p)) for each pixel to obtain the class-based regularized correlation.

6. The class-incremental semantic segmentation learning device according to claim 1,
wherein the processors
transform the class-based representative feature vector obtained from the existing feature map into a transformed class-based representative feature vector using the class-based rotation matrix,
calculate a transformation loss according to a relationship between the transformed class-based representative feature vector and the class-based representative feature vector obtained from the incremental feature map, and
set the class-based rotation matrix so that the transformation loss is reduced.

7. The class-incremental semantic segmentation learning device according to claim 6,
wherein the processors
calculate a fidelity loss calculated as a similarity between the transformed class-based representative feature vector and the class-based representative feature vector obtained from the incremental feature map,
calculate a regularization loss by applying a softmax function to the transformed class-based representative feature vector, and
calculate the transformation loss by weighting the fidelity loss and the regularization loss.

8. The class-incremental semantic segmentation learning device according to claim 6,
wherein a class-based skew-symmetric matrix (S_{c}) is obtained from a class-based strictly upper triangular matrix (U_{c}) having an arbitrary value according to Equation
S_{c}=U_{c}−U_{c}^{T}, and
the class-based rotation matrix has an initial value, set from the class-based skew-symmetric matrix (S_{c}) according to Equation
$${R}_{c} = ( I - {S}_{c} ) {( I + {S}_{c} )}^{- 1}$$
(wherein, I is the identity matrix).

9. The class-incremental semantic segmentation learning device according to claim 1,
wherein the processors
input the transformed class-based feature vector using the class-based rotation matrix during the further learning into a classification module of the incremental semantic segmentation neural network including a feature extraction module and the classification module, and
calculate a difference between the class classified by the classification module and the class of the class-based feature vector as an additional loss and perform backpropagation.

10. The class-incremental semantic segmentation learning device according to claim 9,
wherein the processors
fix the feature extraction module so that the additional loss is not backpropagated during the further learning.

11. A class-incremental semantic segmentation learning method performed by a computing device having one or more processors and a memory, comprising the steps of:
obtaining an incremental semantic segmentation neural network by performing incremental learning on the basis of incremental learning data for an additional incremental class on a previously trained existing semantic segmentation neural network so as to classify an existing learning class according to existing learning data;
after incremental learning with class-based feature vectors, extracted from a previous feature map estimated by the previously trained existing semantic segmentation neural network and pre-stored, obtaining a class-based representative feature vector by estimating a correlation between an existing feature map and an incremental feature map obtained from the existing semantic segmentation neural network and the incremental semantic segmentation neural network, respectively;
performing transformation learning which sets a class-based rotation matrix on the basis of the class-based representative feature vector; and
performing further learning by inputting transformed class-based feature vector into the semantic segmentation neural network using the class-based rotation matrix.

12. The class-incremental semantic segmentation learning method according to claim 11,
wherein the class-based feature vectors are obtained by
extracting pixel-based feature vectors from the previous feature map estimated by the existing semantic segmentation neural network after previous training, and
calculating an average of pixel-based feature vectors with the same class labeled in the existing learning data.

13. The class-incremental semantic segmentation learning method according to claim 11,
wherein the step of obtaining a class-based representative feature vector includes
inputting the incremental learning data into each of the existing semantic segmentation neural network and the incremental semantic segmentation neural network to obtain the existing feature map and the incremental feature map, and
calculating a regularized correlation between the class-based feature vectors and a feature vector for each pixel of the existing feature map to obtain a class-based regularized correlation.

14. The class-incremental semantic segmentation learning method according to claim 13,
wherein the step of obtaining a class-based representative feature vector includes
obtaining a class-based representative feature vector for each of the existing and incremental feature maps by weighting each of a feature vector for each pixel extracted from the existing feature map and the feature vector for each pixel extracted from the incremental feature map with the class-based regularized correlation.

15. The class-incremental semantic segmentation learning method according to claim 13,
wherein the step of obtaining a class-based representative feature vector includes
calculating the class-based correlation (v_{c}(p)) for each pixel from the class-based feature vector (m_{c}^{t-1}(s)) and the feature vector (f^{t-1}(p)) for each pixel extracted from the existing feature map (f^{t-1}) according to Equation
$${υ}_{c} ( p ) = {\sum }_{s = 1}^{S} ReLu ( \frac{{f}^{t - 1} ( p )}{‖ {f}^{t - 1} ( p ) ‖} \cdot \frac{{m}_{c}^{t - 1} ( s )}{‖ {m}_{c}^{t - 1} ( s ) ‖} )$$
(wherein, ReLU is the Rectified Linear Unit function, and |·∥ is the L1-norm function.), and
applying a softmax function to the calculated class-based correlation (v_{c}(p)) for each pixel to obtain the class-based regularized correlation.

16. The class-incremental semantic segmentation learning method according to claim 11,
wherein the step of performing transformation learning includes
transforming the class-based representative feature vector obtained from the existing feature map into a transformed class-based representative feature vector using the class-based rotation matrix,
calculating a transformation loss according to a relationship between the transformed class-based representative feature vector and the class-based representative feature vector obtained from the incremental feature map, and
setting the class-based rotation matrix so that the transformation loss is reduced.

17. The class-incremental semantic segmentation learning method according to claim 16,
wherein the step of performing transformation learning includes
calculating a fidelity loss calculated as a similarity between the transformed class-based representative feature vector and the class-based representative feature vector obtained from the incremental feature map,
calculating a regularization loss by applying a softmax function to the transformed class-based representative feature vector, and
calculating the transformation loss by weighting the fidelity loss and the regularization loss.

18. The class-incremental semantic segmentation learning method according to claim 16,
wherein a class-based skew-symmetric matrix (S_{c}) is obtained from a class-based strictly upper triangular matrix (U_{c}) having an arbitrary value according to Equation
S_{c}=U_{c}−U_{c}^{T}, and
the class-based rotation matrix has an initial value, set from the class-based skew-symmetric matrix (S_{c}) according to Equation
$${R}_{c} = ( I - {S}_{c} ) {( I + {S}_{c} )}^{- 1}$$
(wherein, I is the identity matrix).

19. The class-incremental semantic segmentation learning method according to claim 11,
wherein the step of performing further learning includes
inputting the transformed class-based feature vector using the class-based rotation matrix during the further learning into a classification module of the incremental semantic segmentation neural network including a feature extraction module and the classification module, and
calculating a difference between the class classified by the classification module and the class of the class-based feature vector as an additional loss and performing backpropagation.

20. The class-incremental semantic segmentation learning method according to claim 19,
wherein the step of performing further learning includes
fixing the feature extraction module so that the additional loss is not backpropagated during the further learning.
